(19) United States
(12) Patent Application Publication
(10) Pub. No.: US 2006/0010662 A1
(43) Pub. Date: Jan. 19, 2006

(54) Clamping piece for holding a window pane in a window lifter

(75) Inventor: Thomas Heyer, Sassenburg (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/181,224

(22) Filed: Jul. 13, 2005

(30) Foreign Application Priority Data
Jul. 14, 2004 (DE) 10 2004 033 984.8

(51) Int. Cl. B42F 1/00

(52) U.S. Cl. 24/569

(57) ABSTRACT

The invention relates to a clamping piece for holding a window pane in a window lifter. The clamping piece includes an annular lug that is configured in one piece with the clamping piece, and into which a thread-forming bolt can be screwed. The clamping piece is pulled towards a counter piece by the bolt in order to clamp the window pane between the clamping piece and the counter piece.

### BACKGROUND OF THE INVENTION

The application claims priority to DE 10 2004 033 984.8 which was filed on Jul. 14, 2004.

The invention relates to a clamping piece for holding a window pane in a window lifter. The clamping piece cooperates with a counter piece in order to clamp therebetween a movable window pane of a motor vehicle. The window pane can be moved by the window lifter between an open and a closed position. To this end, the clamping piece and the counter piece are fastened to a carriage, for instance, which can be moved by a mechanism of the window lifter, e.g. in a guide rail. The movement of the carriage, for instance in vertical direction, is transferred to the window pane via the clamping piece and the counter piece.

A bolt is commonly used to fasten the clamping piece to the counter piece. The bolt is screwed into a thread on the clamping piece. Traditionally, this thread is provided on a nut configured as a separate component, and which is fastened to the clamping piece. This will be explained briefly in the following with respect to FIGS. 1 to 3.

FIG. 1 shows a clamping piece 5 mounted to a counter piece 7. A window pane is inserted between the clamping piece 5 and the counter piece 7, which is indicated here by lower edge R. A clamping rubber piece 9 is arranged between the window pane and clamping piece 5 and between the window pane and counter piece 7. The clamping rubber piece 9 enhances friction and protects the window pane. The counter piece 7 is connected with a carriage 10, which is connected with a mechanism of a window lifter (not illustrated).

The clamping piece 5 is pulled towards the counter piece 7 by a bolt 11, which is screwed into a nut 13 shown more clearly in FIGS. 2-3. The nut 13 is a separate component that is inserted in an appropriate opening of the clamping piece 5 and is fixed at this place by pressing or caulking.

This construction is disadvantageous, because it entails a relatively high expenditure in manufacturing. The nut 13 has to produced as a separate component and then has to be mounted to the clamping piece 5. Moreover, a special expenditure is required to fasten the nut 13 to the clamping piece 5 in such a reliable manner that the nut 13 will not come loose when the bolt 11 is repeatedly tightened and untightened.

It is the object of the invention to provide a clamping piece that can be produced under low expenditure and in which the nut can be repeatedly tightened and untightened.

### SUMMARY OF THE INVENTION

To accomplish this objective, the subject invention provides a clamping piece comprising an annular lug that is configured in one piece with the clamping piece, and in which a thread-forming bolt can be screwed. The bolt pulls the clamping piece towards a counter piece in order to clamp a window pane between the clamping piece and the counter piece. The invention is based on the idea of eliminating the nut. In order to ensure that the bolt still has a reliable grip and the clamping piece can be pulled towards the counter piece, a lug is provided that is made in one piece with the clamping piece, and in which several turns can be formed. In this way a required tensile force is reliably provided. Further, the thread in the lug can be loaded to such an extent that the bolt can be tightened and untightened several times, for instance with maintenance or service activities in which the window pane has to be dismounted from the window lifter.

A low expenditure is involved to produce the lug on the clamping piece by deep-drawing or pressing, as the clamping piece usually is made of metal. The lug preferably has a wall thickness that is larger than a remaining wall thickness of the clamping piece. This can be ensured by suitable parameters during drawing of the lug. If necessary, the lug may subsequently be upset and/or calibrated in order to obtain the desired wall thickness. Upsetting is a processing step in which the lug is compressed and plastically deformed. Calibration is a processing step in which an opening in the lug is precisely defined by using a die, punch, or by machining for example.

These and other features of the present invention can be best understood from the following specification and drawings, the following of which is a brief description.

### BRIEF DESCRIPTION OF THE DRAWINGS

FIG. 1 shows a perspective view of a clamping piece together with a counter piece according to the prior art.

FIG. 2 shows an enlarged view of the clamping piece of FIG. 1.

FIG. 3 shows a further enlarged view of a detail from FIG. 2.

FIG. 4 shows an assembly unit consisting of a counter piece, a bolt and a clamping piece according to the invention.

FIG. 5 shows an enlarged view of the clamping piece of FIG. 4.

FIG. 6 shows a further enlarged view of a detail from FIG. 5.

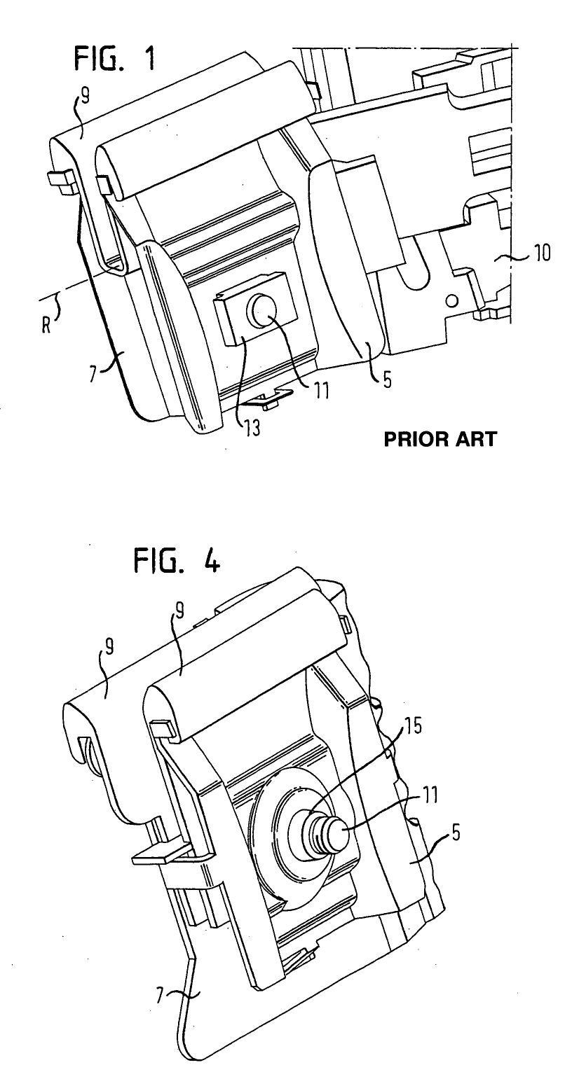

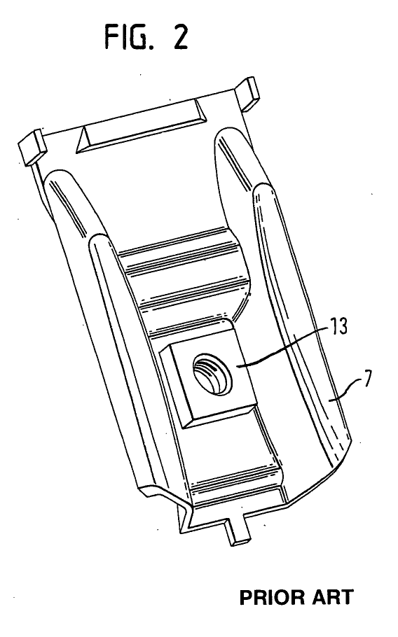

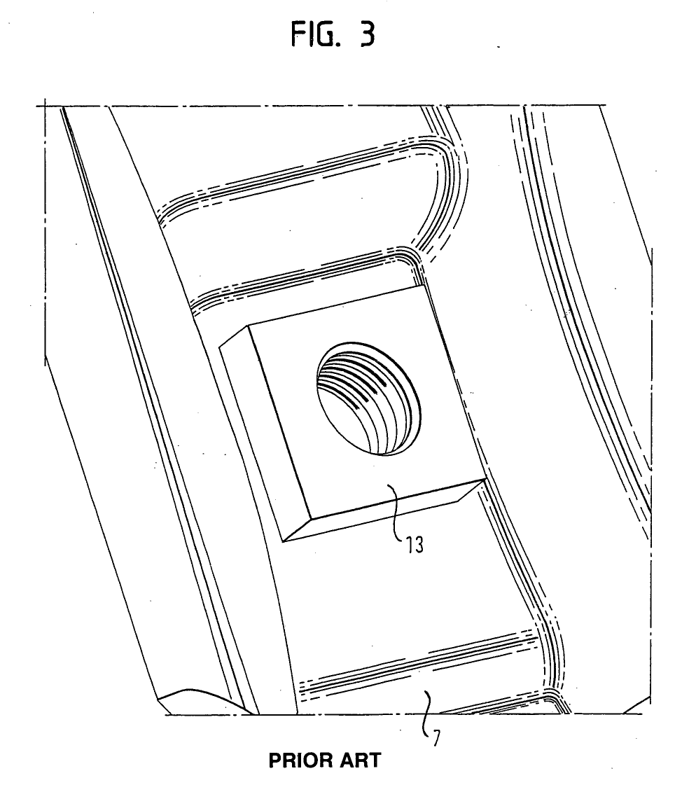

### DETAILED DESCRIPTION OF THE PREFERRED EMBODIMENT

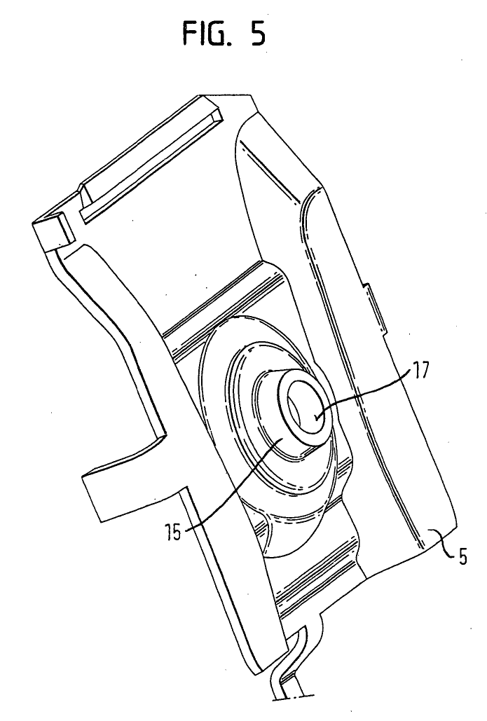

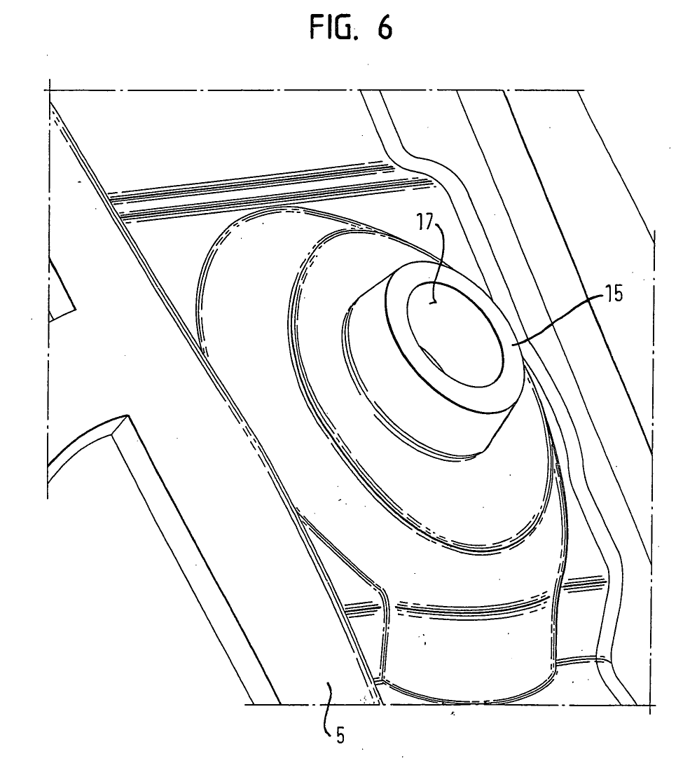

FIG. 4 shows a clamping piece 5 mounted to a counter piece 7. There is further provided a bolt 11, the head (not visible) of which rests against the counter piece 7, and a threaded shaft of which engages in the clamping piece 5. The clamping piece 5 includes a lug 15 (see also FIG. 4) that is made in one piece with the clamping piece 5. The lug 15 is of annular shape and protrudes from the clamping piece 5 at a side facing away from the counter piece 7. The lug 15 has a cylindrical inner surface 17 with an inner diameter that is adapted to the bolt 11 such that a female thread will be formed in the cylindrical inner surface 17 of lug 15 when the bolt 11 is screwed in. The bolt 11 may be designed such that the bolt 11 forms the female thread in the lug 15 by rolling, or by cutting in case the bolt 11 is configured as a self-tapping bolt.

The annular lug 15 is configured such that its wall thickness provides a desired strength of the thread formed therein. If the wall thickness of the clamping piece 5 is already comparably large, for instance 3 mm, the wall thickness of the lug 15 may be equal to the wall thickness of the remaining body of the clamping piece 5. If the clamping piece 5 is configured to have a comparably small wall thickness, however, the lug 15 may be made such that its wall thickness is larger than the remaining wall thickness of the clamping piece 5. This provides a high strength of the thread formed in the lug 15 and, hence, a high clamping torque for the bolt 11.

Also, the wall thickness of the lug 15 could be larger in a transition region to a body of the clamping piece 5 than on an end face of the lug 15. Such a parameter is another way to influence the strength of the formed thread.

The clamping piece 5 is made of metal and produced by punching, stamping, pressing or deep-drawing. The cylindrical lug 15 is pressed or deep-drawn, too. This results in a very low expenditure in manufacturing. As the entire clamping piece 5 is made from one single piece, there will be no expenditure for mounting additional components. Further, there is no risk of an incorrect mounting of additional components.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A clamp for holding a window pane in a window lifter comprising:
a clamping piece; and
an annular lug configured in one piece with the clamping piece wherein a thread-forming bolt is screwed into the annular lug such that the clamping piece is pulled towards a counter piece in order to clamp a window pane between the clamping piece and the counter piece.

2. The clamp according to claim 1 wherein the annular lug has a wall thickness that is larger than a remaining wall thickness of the clamping piece.

3. The clamp according to claim 1 wherein the annular lug is deep-drawn.

4. The clamp according to claim 1 wherein the annular lug is upset.

5. The clamp according to claim 1 wherein the annular lug has a smooth inner opening.

6. The clamp according to claim 1 wherein the annular lug has a calibrated inner opening.

7. The clamp according to claim 1 wherein the annular lug has a female thread that is formed by the thread-forming bolt.

8. The clamp according to claim 1 wherein the clamping piece is made from a sheet of metal.

9. An assembly unit for holding a window pane in a window lifter comprising:
a clamping piece including an annular lug formed in one piece with the clamping piece;
a counter piece; and
a thread-forming bolt wherein the annular lug has a female thread that is formed by the thread-forming bolt.

10. The assembly unit according to claim 9 wherein the female thread is formed by one of rolling and cutting.
